(19) United States
(12) Patent Application Publication
(10) Pub. No.: US 2015/0102976 A1
(43) Pub. Date: Apr. 16, 2015

(54) COMMUNICATION DEVICE AND ANTENNA ELEMENT THEREIN

(71) Applicant: Acer Incorporated, New Taipei City (TW)

(72) Inventors: Kin-Lu Wong, New Taipei City (TW); Li-Yu Chen, New Taipei City (TW)

(73) Assignee: Acer Incorporated, New Taipei City (TW)

(21) Appl. No.: 14/100,477

(22) Filed: Dec. 9, 2013

(30) Foreign Application Priority Data
Oct. 11, 2013 (TW) 102136690

(51) Int. Cl. H01Q 5/00

(52) U.S. Cl. CPC H01Q 5/0093
USPC 343/860

(57) ABSTRACT

A communication device includes a ground element and an antenna element. The antenna element is adjacent to an edge of the ground element, and includes a first metal element and a second metal element. A first end of the first metal element is coupled through a first shorting element to the ground element. A second end of the first metal element is open and adjacent to the first end. The second metal element is between the first metal element and the edge of the ground element. A shorting point on the second metal element is coupled through a second shorting element to the ground element. A feeding point on the second metal element is coupled through a capacitive element to a signal source. A third end of the second metal element is adjacent to the first shorting element. A fourth end of the second metal element is open.

### CROSS REFERENCE TO RELATED APPLICATIONS

This Application claims priority of Taiwan Patent Application No. 102136690 filed on Oct. 11, 2013, the entirety of which is incorporated by reference herein.

### BACKGROUND OF THE INVENTION

1. Field of the Invention

The disclosure generally relates to a communication device, and more particularly, relates to a communication device and a small-size multi-band inverted-F antenna element therein.

2. Description of the Related Art

With the rapid development of mobile communication technologies, a variety of related products are continuously promoted and innovated. Nowadays, mobile communication devices require higher transmission speeds to provide convenience and immediacy of use for users. Since the design of mobile communication devices becomes lighter and thinner, the spacing between its display and frame may become much smaller. As a result, there is reduced space for accommodating antenna elements. Accordingly, it is a critical challenge for antenna designers to design a planar, small-size, and multi-band antenna in a thin mobile communication device.

### BRIEF SUMMARY OF THE INVENTION

The invention provides an inverted-F antenna, which has a small-size planar structure and is configured to cover LTE/WWAN (Long Term Evolution/Wireless Wide Area Network) multiple bands (e.g., from about 704 MHz to about 960 MHz, and from about 1710 MHz to about 2690 MHz).

In a preferred embodiment, the invention provides a communication device, comprising: a ground element; and an antenna element, disposed adjacent to an edge of the ground element, wherein the antenna element comprises: a first metal element, having a first end and a second end, wherein the first end is coupled through a first shorting element to the ground element, and the second end is open and adjacent to the first end; and a second metal element, disposed between the first metal element and the edge of the ground element, and having a third end and a fourth end, wherein a shorting point on the second metal element is coupled through a second shorting element to the ground element, a feeding point on the second metal element is coupled through a capacitive element to a signal source, the third end is adjacent to the first shorting element, the fourth end is open, and the feeding point is positioned between the third end and the shorting point.

In some embodiments, the second metal element is substantially parallel to the edge of the ground element, and a coupling gap is formed between the second metal element and the first metal element. In some embodiments, the second metal element substantially has an inverted U-shape, and the third end of the second metal element is open. In some embodiments, the second metal element substantially has an inverted L-shape, and the third end of the second metal element is open. In some embodiments, the first metal element substantially has an inverted U-shape. In some embodiments, the first metal element substantially extends and surrounds a rectangular region. In some embodiments, the first metal element substantially extends and surrounds an inverted L-shaped region.

It can be considered that the antenna element substantially comprises a first inverted-F antenna and a second inverted-F antenna, and the first inverted-F antenna is configured as a coupling-feed element of the second inverted-F antenna. In some embodiments, a feeding point of the first inverted-F antenna is further coupled through a capacitive element (e.g., a chip capacitor) to the signal source such that a capacitively coupled-fed structure is formed. The foregoing design causes the first inverted-F antenna to be excited to generate a first resonant mode with good impedance matching. The first resonant mode occurs in a first (high-frequency) band of the antenna element. In some embodiments, the first band is substantially from 1710 MHz to 2690 MHz.

On the other hand, since the first inverted-F antenna is configured as the coupling-feed element of the second inverted-F antenna, the second inverted-F antenna may be further excited to generate a second resonant mode with wide bandwidth. The second resonant mode occurs in a second (low-frequency) band of the antenna element. In some embodiments, the second band is substantially from 704 MHz to 960 MHz. In some embodiments, a radiation element (the first metal element) of the second inverted-F antenna substantially has an inverted U-shape, or it substantially extends and surrounds a rectangular region or an inverted L-shaped region. Since the two adjacent portions of the first metal element are close to each other, it causes a higher-order resonant mode of the second inverted-F antenna to be shifted to lower frequencies. The higher-order resonant mode may be shifted into the first band and combined with the first resonant mode of the first inverted-F antenna, thereby significantly increasing the bandwidth of the first band.

In some embodiments, the capacitive element is disposed between the second metal element and the edge of the ground element. That is, the capacitive element is disposed inside a clearance region of the antenna element. In some embodiments, the capacitive element is disposed on the ground element. In some embodiments, the second shorting element further comprises an inductive element, and the shorting point on the second metal element is coupled through the inductive element to the ground element. The inductive element is used to adjust an effective inductance of the second shorting element, thereby further improving the impedance matching of the resonant modes of the antenna element.

In some embodiments, the antenna element has a small-size planar structure (e.g., its area is about 10×38 mm²) and is configured to cover multiple bands, which are substantially from about 704 MHz to about 960 MHz and from about 1710 MHz to about 2690 MHz. Therefore, the antenna element of the invention can support at least LTE/WWAN multi-band operations of thin tablet communication devices.

### BRIEF DESCRIPTION OF DRAWINGS

The invention can be more fully understood by reading the subsequent detailed description and examples with references made to the accompanying drawings, wherein:

FIG. 1 is a diagram for illustrating a communication device according to a first embodiment of the invention;

FIG. 2 is a diagram for illustrating a communication device according to a second embodiment of the invention;

FIG. 3 is a diagram for illustrating a communication device according to a third embodiment of the invention;

FIG. 4 is a diagram for illustrating return loss of an antenna element of a communication device according to a third embodiment of the invention; and

FIG. 5 is a diagram for illustrating antenna efficiency of an antenna element of a communication device according to a third embodiment of the invention.

### DETAILED DESCRIPTION OF THE INVENTION

In order to illustrate the foregoing and other purposes, features and advantages of the invention, the embodiments and figures thereof in the invention are described in detail as follows.

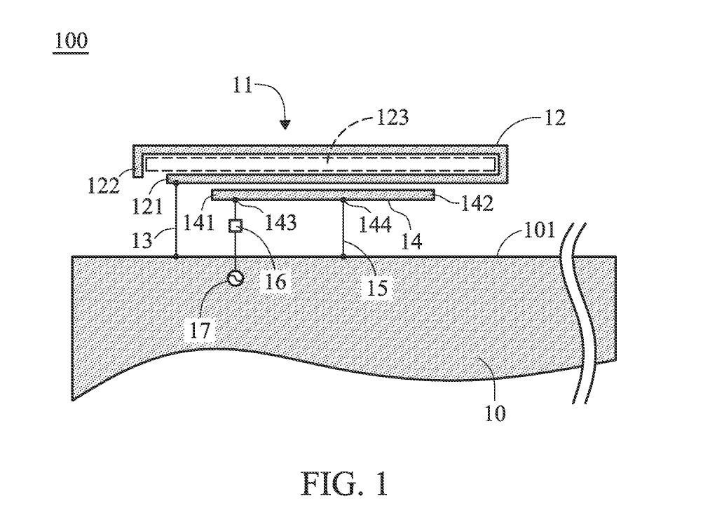

FIG. 1 is a diagram for illustrating a communication device 100 according to a first embodiment of the invention. The communication device 100 may be a smartphone, a tablet computer, or a notebook computer. As shown in FIG. 1, the communication device 100 at least comprises a ground element 10 and an antenna element 11. The antenna element 11 is disposed adjacent to an edge 101 of the ground element 10. The antenna element 11 comprises a first metal element 12 and a second metal element 14. The first metal element 12 has a first end 121 and a second end 122. The first end 121 of the first metal element 12 is coupled through a first shorting element 13 to the ground element 10. The second end 122 of the first metal element 12 is open and adjacent to the first end 121 of the first metal element 12. In some embodiments, the first metal element 12 substantially has an inverted U-shape, and the first metal element 12 substantially extends and surrounds a rectangular region 123. The second metal element 14 is disposed between the first metal element 12 and the edge 101 of the ground element 10. The second metal element 14 has a third end 141 and a fourth end 142. In some embodiments, the second metal element 14 substantially has a straight-line shape. In some embodiments, the second metal element 14 is substantially parallel to the edge 101 of the ground element 10, and a coupling gap is formed between the second metal element 14 and the first metal element 12. The third end 141 of the second metal element 14 is adjacent to the first shorting element 13. The fourth end 142 of the second metal element 14 is open. A feeding point 143 on the second metal element 14 is coupled through a capacitive element 16 to a signal source 17. The signal source 17 may be an RF (Radio Frequency) module for exciting the antenna element 11. The capacitive element 16 may be a chip capacitor. A shorting point 144 on the second metal element 14 is coupled through a second shorting element 15 to the ground element 10. The feeding point 143 is positioned between the third end 141 of the second metal element 14 and the shorting point 144. It may be considered that the antenna element 11 substantially comprises a first inverted-F antenna (the second metal element 14) and a second inverted-F antenna (the first metal element 12), and the first inverted-F antenna may be configured as a coupling-fed element of the second inverted-F antenna. As a result, the antenna element 11 is capable of covering multiple bands. Note that the communication device 100 may further comprise other components, such as a touch panel, a processor, a speaker, a battery, and a housing (not shown).

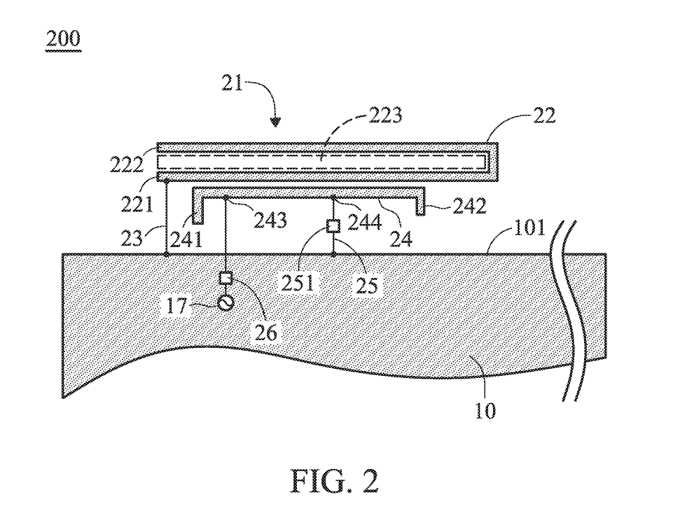

FIG. 2 is a diagram for illustrating a communication device 200 according to a second embodiment of the invention. FIG. 2 is similar to FIG. 1. The differences between the two embodiments are described as follows. In the communication device 200, a first metal element 22 of an antenna element 21 substantially has an inverted U-shape, and/or substantially extends and surrounds a rectangular shape 223. A second metal element 24 of the antenna element 21 substantially has an inverted U-shape. A third end 241 and a fourth end 242 of the second metal element 24 are both open. A second shorting element 25 relative to the second metal element 24 further comprises an inductive element 251, and a shorting point 244 on the second metal element 24 is coupled through the inductive element 251 to the ground element 10. The inductive element 251 may be a chip inductor, a distributed inductor, or a combination thereof. A capacitive element 26 coupled to the signal source 17 is disposed on the ground element 10. Other features of the second embodiment are similar to those of the first embodiment. Accordingly, the two embodiments can achieve similar performances.

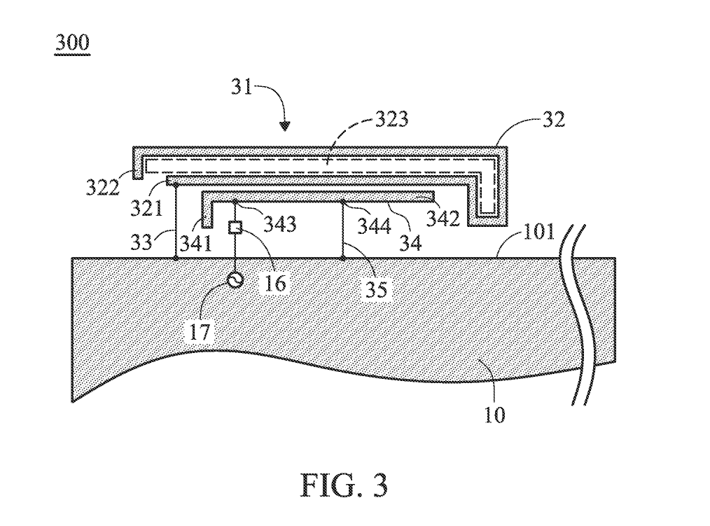

FIG. 3 is a diagram for illustrating a communication device 300 according to a third embodiment of the invention. FIG. 3 is similar to FIG. 1. The differences between the two embodiments are described as follows. In the communication device 300, a first metal element 32 of an antenna element 31 substantially extends and surrounds an inverted L-shaped region 323. A second metal element 34 of the antenna element 31 substantially has an inverted L-shape. A third end 341 and a fourth end 342 of the second metal element 34 are both open. Other features of the third embodiment are similar to those of the first embodiment. Accordingly, the two embodiments can achieve similar performances.

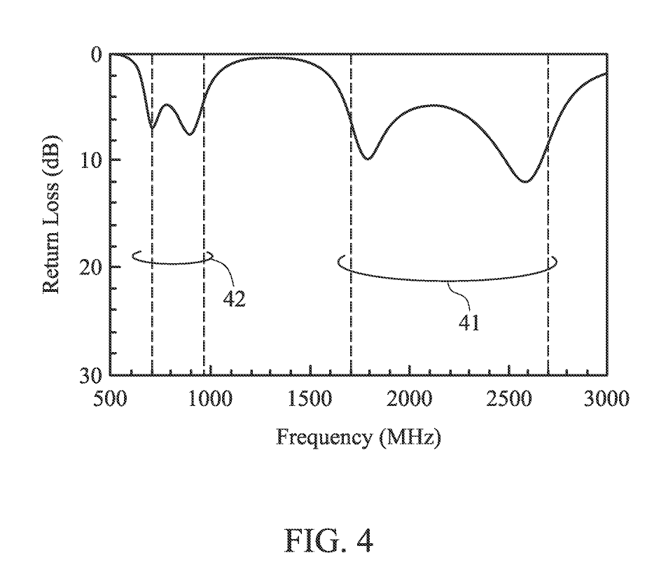

FIG. 4 is a diagram for illustrating return loss of the antenna element 31 of the communication device 300 according to the third embodiment of the invention. In some embodiments, the sizes and parameters of the elements of the communication device 300 are described as follows. The ground element 10 has a length of about 150 mm and a width of about 200 mm. The antenna element 31 substantially has a planar structure which has an area of about 10×38 mm². The first metal element 32 has a length of about 89 mm. The first shorting element 33 has a length of about 5 mm. The second metal element 34 has a length of about 24 mm. The second shorting element 35 has a length of about 9 mm. The capacitive element 16 has a capacitance of about 2 pF. According to the measurement result of FIG. 4, the antenna element 31 may be excited to generate a first band 41 and a second band 42. The first band 41 may cover GSM1800/1900/UMTS/LTE2300/2500 communication bands (from about 1710 MHz to about 2690 MHz), and the second band 42 may cover LTE700/GSM850/900 communication bands (from about 704 MHz to about 960 MHz).

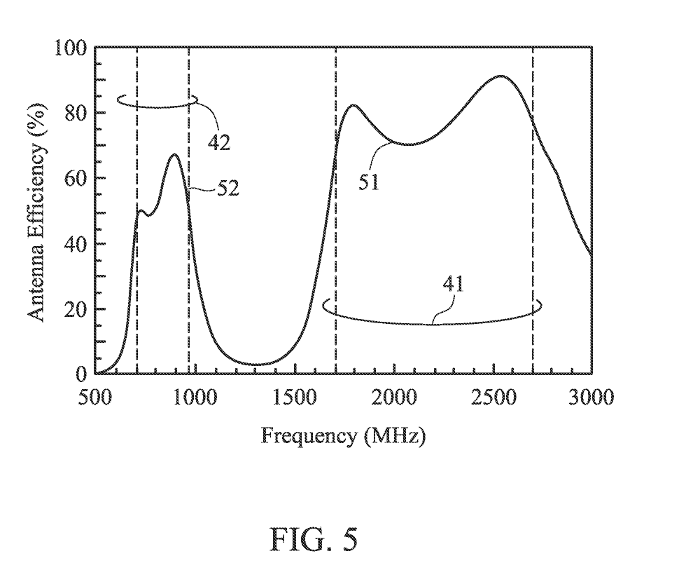

FIG. 5 is a diagram for illustrating antenna efficiency of the antenna element 31 of the communication device 300 according to the third embodiment of the invention. It is understood that the aforementioned antenna efficiency is the radiation efficiency including the return loss. The first antenna efficiency curve 51 represents the antenna efficiency of the antenna element 31 operating in the first bands 41 (from about 1710 MHz to about 2690 MHz). The second antenna efficiency curve 52 represents the antenna efficiency of the antenna element 31 operating in the second band 42 (from about 704 MHz to about 960 MHz). According to the measurement result of FIG. 5, the antenna efficiency of the antenna element 31 operating in the first bands 41 is from about 67% to about 90%, and the antenna efficiency of the antenna element 31 operating in the second bands 42 is from about 47% to about 66%. It can meet the requirements of practical applications.

Note that the above element sizes, element shapes, and frequency ranges are not limitations of the invention. An antenna designer can change these settings according to different requirements.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a ground element; and
an antenna element, disposed adjacent to an edge of the ground element, wherein the antenna element comprises:
a first metal element, having a first end and a second end, wherein the first end is coupled through a first shorting element to the ground element, and the second end is open and adjacent to the first end; and
a second metal element, disposed between the first metal element and the edge of the ground element, and having a third end and a fourth end, wherein a shorting point on the second metal element is coupled through a second shorting element to the ground element, a feeding point on the second metal element is coupled through a capacitive element to a signal source, the third end is adjacent to the first shorting element, the fourth end is open, and the feeding point is positioned between the third end and the shorting point.

2. The communication device as claimed in claim 1, wherein the capacitive element is disposed between the second metal element and the edge of the ground element.

3. The communication device as claimed in claim 1, wherein the capacitive element is disposed on the ground element.

4. The communication device as claimed in claim 1, wherein the second metal element is substantially parallel to the edge of the ground element, and a coupling gap is formed between the second metal element and the first metal element.

5. The communication device as claimed in claim 1, wherein the second metal element substantially has an inverted U-shape, and the third end of the second metal element is open.

6. The communication device as claimed in claim 1, wherein the second metal element substantially has an inverted L-shape, and the third end of the second metal element is open.

7. The communication device as claimed in claim 1, wherein the first metal element substantially has an inverted U-shape.

8. The communication device as claimed in claim 1, wherein the first metal element substantially extends and surrounds a rectangular region.

9. The communication device as claimed in claim 1, wherein the first metal element substantially extends and surrounds an inverted L-shaped region.

10. The communication device as claimed in claim 1, wherein the second shorting element further comprises an inductive element, and the shorting point on the second metal element is coupled through the inductive element to the ground element.
